(19) United States
(12) Patent Application Publication
(10) Pub. No.: US 2010/0268897 A1
(43) Pub. Date: Oct. 21, 2010

(54) MEMORY DEVICE AND MEMORY DEVICE CONTROLLER

(76) Inventors: Keishi OKAMOTO, Osaka (JP); Takeshi Otsuka, Hyogo (JP); Hideaki Yamashita, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/760,842

(22) Filed: Apr. 15, 2010

(30) Foreign Application Priority Data
Apr. 16, 2009 (JP) 2009-099811

(51) Int. Cl. G06F 12/00

(52) U.S. Cl. 711/154; 711/E12.001

(57) ABSTRACT

A memory device controller interposed between a memory device and a host device includes a data communication unit configured to transfer data to and from the memory device in synchronization with a clock signal. The data communication unit supports a single edge synchronization mode in which data is transferred in synchronization with either one of a rising edge and a falling edge of the clock signal, and a double edge synchronization mode in which data is transferred in synchronization with both the rising edge and the falling edge. The data communication unit transfers data in the double edge synchronization mode when data is transferred by the memory device operating as a bus master.

### BACKGROUND ART

1. Technical Field

The present invention relates to a memory device, such as a nonvolatile memory having a general-purpose interface (I/F) used for a recording medium for a personal computer (PC) or a digital camera, and further relates to a memory device controller.

2. Related Art

There have been a memory device controller (adaptor) which allows a PC to use a memory device. In some cases, in a memory device and a memory device controller, their respective buses operate at different speeds. For example, in cases where a memory device employs a SD card I/F while a PC employs a PCI bus I/F, a memory device controller performs adjustments between data transfer conforming to the SD card I/F and data transfer conforming to the PCI bus I/F. In such a case, in a system enabling changing of an operation clock for them, it is necessary to enable data transfer between both buses regardless of the operation clock and the data width.

In order to overcome the problem, for example, JP 2006-195948A discloses placing, in parallel, plural bus bridges corresponding to various frequencies and selecting a bus bridge according to relation of clock-frequency between a memory device and a memory device controller, in order to enable communication between the two buses which operate at different speeds.

FIG. 10 illustrates the structure of a conventional memory device and a conventional memory device controller (an adaptor) which are disclosed in JP2006-195948A.

In FIG. 10, an adaptor 102 is connected between a host PC 101 and a memory device 103. The adaptor 102 includes first to fourth bus bridges 1021 to 1024 each of which operates at the respective operation frequency, a first selector 1031 which selects a bus bridge according to the operation frequency of the host PC 101, and a second selector 1032 which selects a bus bridge according to the operation frequency of the memory device 103.

As described above, the bus bridges 1021 to 1024 corresponding to various frequencies are structured to be parallel with one another. According to relationship of operation frequency between the host PC 101 and the memory device 103, a single bus bridge which maximizes the transfer speed is selected from the plural bus bridges 1021 to 1024. This enables transfer between the host PC 101 and the memory device 103 with an arbitrary operation clock.

However, with the aforementioned structure, in cases where the memory device employs a standard IF intended for general-purpose PCs, such as a CardBus IF, even if the host PC employs a high-speed IF such as a PCI-Express, the communication speed is restricted by the performance of the CardBus IF, which induces a problem that the maximum performance of the high-speed IF can not be derived.

### SUMMARY

It is an object of the present invention to provide a memory device and a memory device controller which are capable of increasing data transfer speed while maintaining connection compatibility with an apparatus having a conventional interface.

In accordance with a first aspect, a memory device connectable to a host device via a memory device controller is provided. The memory device includes a memory module for storing data, and a data communication unit configured to communicate data with the memory device controller in synchronization with a predetermined clock signal, in order to write or read data to or from the memory module. The data communication unit is capable of transferring data in a single edge synchronization mode in which data is transferred in synchronization with either one of a rising edge and a falling edge of the clock signal or in a double edge synchronization mode in which data is transferred in synchronization with both the rising edge and the falling edge. The memory device can be set to operate as a bus master. When the memory device is set to operate as a bus master, the data communication unit transfers data in the double edge synchronization mode.

In accordance with a second aspect, a memory device controller is provided, which is interposed between a memory device and a host device and is connectable to the memory device through a predetermined interface. The memory device controller includes a data communication unit configured to transfer data to and from the memory device in synchronization with a clock signal. The data communication unit supports a single edge synchronization mode in which data is transferred in synchronization with either one of a rising edge and a falling edge of the clock signal, or a double edge synchronization mode in which data is transferred in synchronization with both the rising edge and the falling edge. The data communication unit transfers data in the double edge synchronization mode when data is transferred by the memory device operating as a bus master.

According to the aforementioned configuration, it is possible to make the memory device operate as a bus master and to transfer data in the double edge synchronization mode. This enables data transfer at a high speed. Further, it is also possible to make the memory device operate in a single edge synchronization mode. This enables eliminating the bottle neck of the transfer performance of the interface in the memory device, thereby realizing transfer performance required by the host PC while maintaining the compatibility with conventional interfaces.

### BRIEF DESCRIPTION OF DRAWINGS

FIG. 1 is a block diagram illustrating a structure of a memory device and an adaptor (a memory device controller) according to a first embodiment.

FIG. 2 is a flow chart illustrating a processing of the adaptor when the memory device is connected thereto, according to the first embodiment.

FIG. 3 is a schematic view illustrating a flow of commands and data between the memory device and the adaptor according to the first embodiment.

FIG. 4 is a schematic view illustrating a flow of commands and data between the memory device and the adaptor according to the first embodiment.

FIG. 5 is a schematic view illustrating a flow of commands and data between a memory device and an adaptor according to a second embodiment.

FIG. 6 is an explanation view illustrating extended function relating to interface specification of the memory device according to the second embodiment.

FIGS. 7A to 7C are views illustrating switch of interface specification of the memory device and the adaptor according to the second embodiment.

FIG. 8 is a block diagram illustrating a structure of a memory device and an adaptor according to a third embodiment.

FIGS. 9A to 9C are views illustrating commands and data between the memory device and the adaptor according to the third embodiment.

FIG. 10 is a block diagram illustrating a structure of a conventional memory device and a conventional adaptor (a memory device controller).

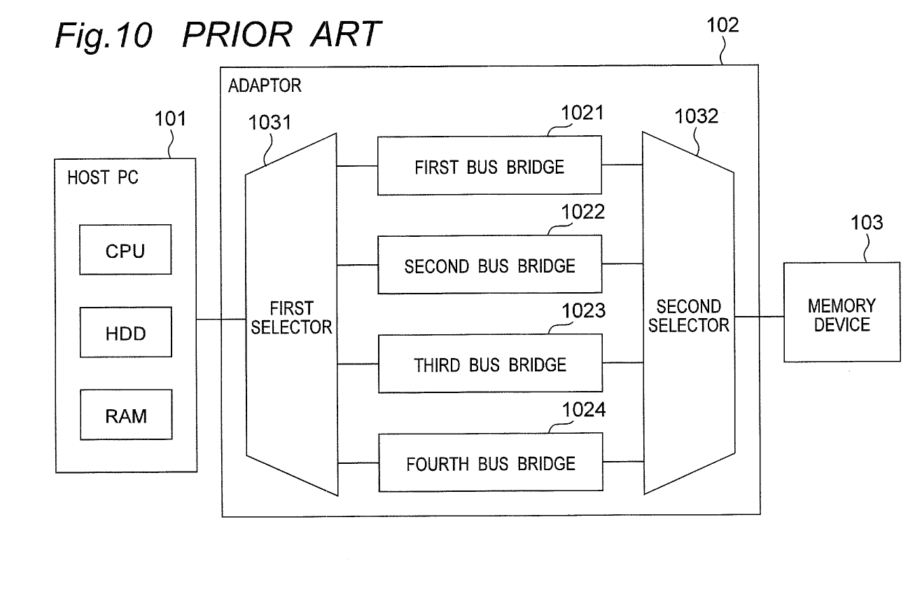

### DETAILED DESCRIPTION OF PREFERRED EMBODIMENTS

Preferred embodiments will be described below, with reference to the accompanying drawings.

### First Embodiment

1. Structure

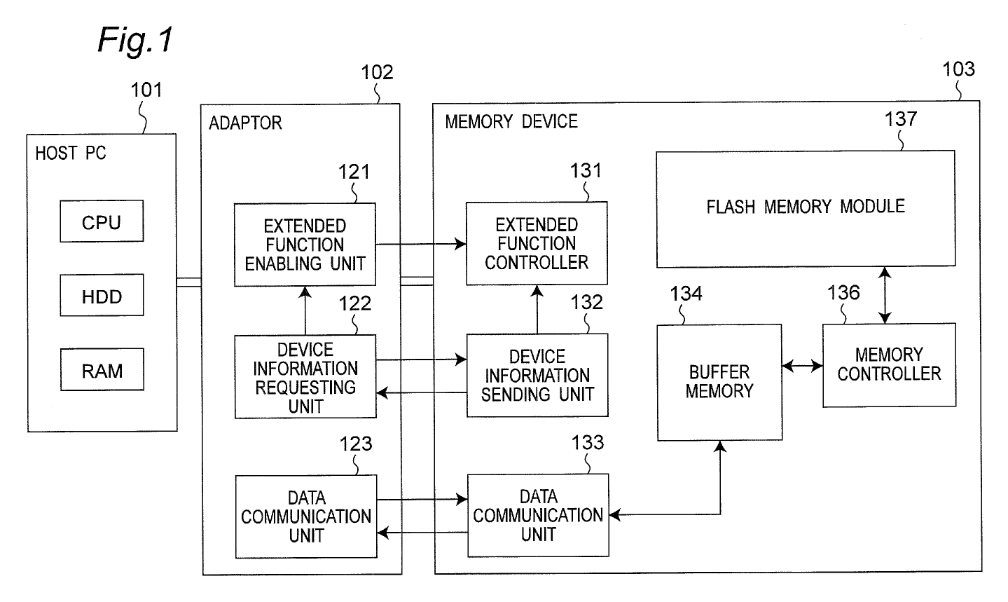

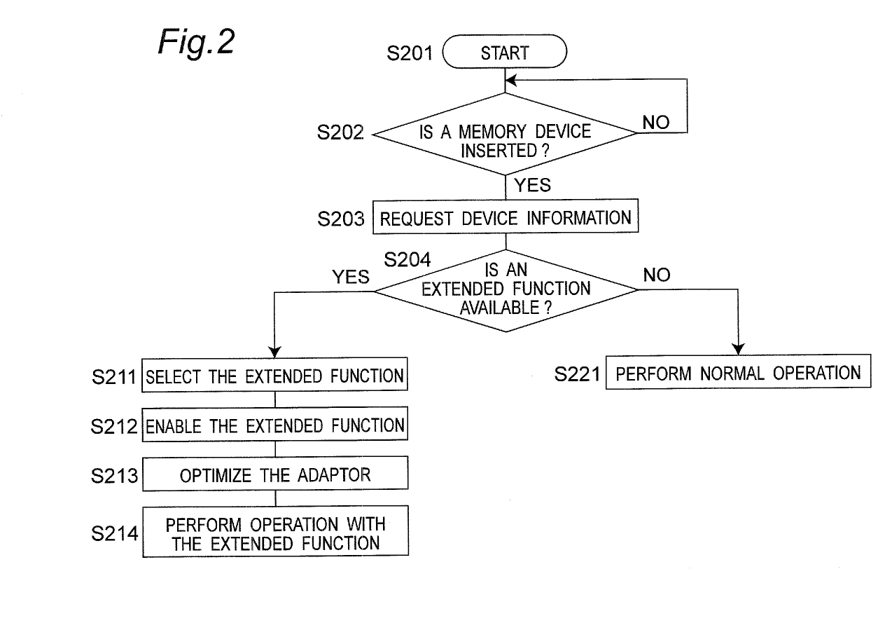

FIG. 1 is a view illustrating a structure of a memory device and an adapter (a memory device controller) according to the first embodiment. FIGS. 2 to 6 are views for describing, in detail, operations of the memory device and the adapter (the memory device controller) according to the present embodiment.

In FIG. 1, a host PC 101 is an information processing apparatus which is typically a personal computer. A memory device 103 incorporates a nonvolatile memory such as a flash memory. An adapter 102 is connected between the host PC 101 and the memory device 103 to enable communication between the host PC 101 and the memory device 103, those having different interfaces. Namely, the adapter 102 is, for example, a device which enables mounting of the memory device 103 (for example, an extended board for the host PC 101).

Between the host PC 101 and the adaptor 102, data is transferred at a speed conforming to a bus interface employed in the host PC 101. In the following description, data transfer between the host PC 101 and the adapter 102 is as those in the prior art and the description thereof will not be given and, mainly, operations for data transfer between the adapter 102 and the memory device 103 will be described.

The adaptor 102 includes an extended function enabling unit 121 for enabling an extended function(s) of the memory device 103, a device information requesting unit 122 for requesting device information from the memory device 103, and a data communication unit 123 for controlling data transfer between the host PC 101 and the memory device 103.

The memory device 103 includes an extended function controller 131 for controlling the extended function, a device information sending unit 132 for transmitting device information in response to a request, a data communication unit 133 for controlling input and output of data, a buffer memory 134 for temporarily storing read data and write data, a flash memory module 137, and a memory controller 136 for controlling writing and reading of data to and from the flash memory module 137. The flash memory module 137 is, for example, a recording medium which is composed of plural SD cards and is capable of storing data in a nonvolatile manner.

The memory device 103 has an extended function(s) which can be enabled by the adaptor 102. It is noted that the extended function is a function which enables data transfer at a speed which is twice the transfer speed of a conventional interface. More specifically, the memory device 103 usually performs data transfer in synchronization with either one of rising edge or falling edge of a clock signal. The extended function includes a function of transferring data in synchronization with both rising edge and falling edge of a clock signal. Hereinafter, synchronization with either one of rising edge or falling edge of a clock signal is referred to as “single edge synchronization”, while synchronization with both rising edge and falling edge of a clock signal is referred to as “double edge synchronization”. Further, a mode which performs data transfer in the single edge synchronization is referred to as “single-edge synchronization mode”, while a mode which performs data transfer in the double edge synchronization is referred to as “double-edge synchronization mode”. The data transfer in the double-edge synchronization mode enables data transfer at a speed which is twice the data transfer speed in the single-edge synchronization mode.

Outline of operations for setting the extended function between the adaptor 102 and the memory device 103 is described below. In order to acquire device information and the like about the memory device 103, the device information requesting unit 122 in the adaptor 102 requests the device information sending unit 132 in the memory device 103 to acquire the device information. The device information includes information about functions and characteristics of the memory device 103 and information necessary for interface. The device information includes, for example, information about speed of writing/reading data to/from the memory device 103, information about current consumption for writing/reading data in the double-edge synchronization mode, and information about current consumption for writing/reading data in the single-edge synchronization mode.

The device information sending unit 132 manages information such as the device information and transmits the device information to the device information requesting unit 122 in response to a request for acquisition of the device information from the device information requesting unit 122.

In order to enable the extended function of the memory device 103 which can be supported by the adaptor 102, the extended function enabling unit 121 in the adaptor 102 requests the extended function controller 131 in the memory device 103 to enable the extended function, based on the device information acquired from the memory device 103. In response to the request from the extended function enabling unit 121, the extended function controller 131 in the memory device 103 enables the extended function of the memory device 103. In the enabling of the extended function, preparation for high speed data transfer (changes of settings) is made. For example, setting of frequency of the clock signal, definition of a new signal terminal for switch from a single end signal to a differentiation signal, setting of an I/O voltage, and the like are changed.

2. Operation

With reference to FIG. 2, the processing of the adaptor 102 when the memory device is connected to the adaptor 102 is described below.

FIG. 2 illustrates a flow chart which starts after the adaptor 102 is powered on and initialization of the adaptor 102 is completed (S201). When the memory device 103 is inserted into the adaptor 102 (S202), the device information requesting unit 122 in the adaptor 102 requests device information from the memory device 103 to acquire the device information from the memory device 103 (S203). The extended function enabling unit 121 in the adaptor 102 determines whether or not the memory device 103 has an extended function(s), based on the acquired device information (S204). This determination can be performed based on determining whether or not the device information contains information indicative of the extended function, for example. If the memory device 103 has the extended function, the extended function is selected (S211). If the memory device 103 has no extended function, a normal operation is executed (S221). In the normal operation, a data transfer operation conforming to a general-purpose IF which is normally provided for the host PC 101.

When the extended function is selected (S211), an extended function to be enabled is selected based on the extended function(s) supported by both the memory device 103 and the adaptor 102. Next, the extended function enabling unit 121 in the adaptor 102 issues a request for enabling the extended function to the extended function controller 131 in the memory device 103 (S212). Subsequently, regarding internal settings of the adaptor 102, the adaptor 102 enables function associated with the extended function to be used (S213). Subsequently, the adaptor 102 accesses the memory device 103 using the extended function (S214).

As described above, when the memory device 103 having extended function(s) is connected to the adaptor 102, the extended function of the memory device 103 is enabled and access to the memory device 103 can be made at a higher data transfer speed. On the other hand, when the memory device 103 having no extended function is connected to the adaptor 102, access to the memory device 103 is made in a normal method, and data transfer is performed at a speed inherent to the interface.

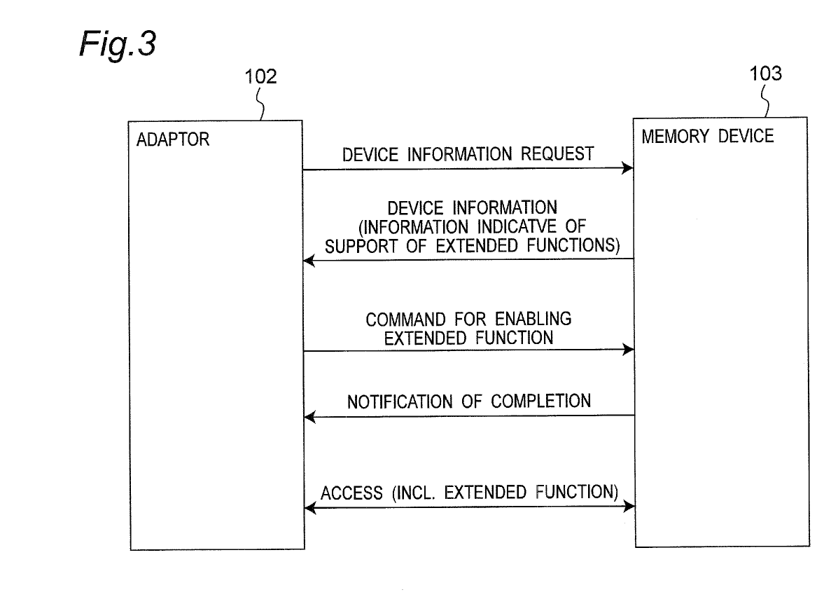

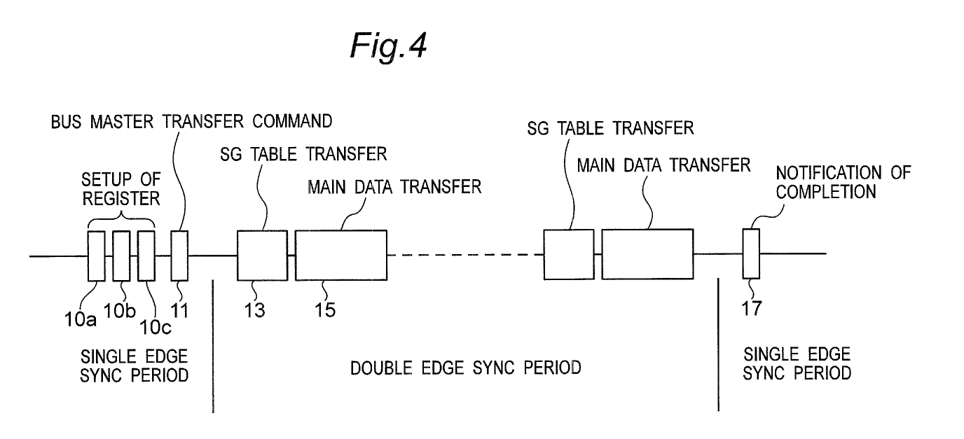

With reference to FIG. 3 and FIG. 4, operation for enabling the extended function of the memory device 103 by the adaptor 102 is detailed below.

FIG. 3 is a view illustrating transmission and reception of commands and data relating to the operation for enabling the extended function between the adaptor 102 and the memory device 103. As illustrated in FIG. 3, at first, the adaptor 102 requests device information from the memory device 103. The memory device 103 transmits the device information to the adaptor 102 in response to the request for the device information from the adaptor 102. As the device information, information is transferred, which includes extended function information such as information indicating availability of data transfer in the double edge synchronization.

Upon receiving the device information from the memory device 103, the adaptor 102 transmits, to the memory device 103, a command for enabling the extended function. The memory device 103 enables the extended function according to the command for enabling the extended function from the adaptor 102. As the enabling the extended function, preparation for transferring data at a high speed is made.

Upon completion of the processing for enabling the extended function, the memory device 103 transmits a notification of the completion to the adaptor 102. The adaptor 102 starts access to the memory device 103 including the extended function thereof, when receiving the notification of the completion of the enabling the extended function from the memory device 103.

Operation for data transfer in the manner of double edge synchronization, using a rising edge and a falling edge of the clock, is detailed below.

FIG. 4 shows a timing chart of one time DMA (Direct Memory Access) transfer sequence.

The host PC 101 sets an address of a Scatter-Gather descriptor table (hereinafter, referred to as an “SG table”) including a transfer source address, a transfer destination address and a transfer size, and other information (10a to 10c) necessary for DMA transfer control, in predetermined registers in the memory device 103, through the adaptor 102. The SG table is stored in a main memory in the host PC 101. Thereafter, the adaptor 102 issues, to the memory device 103, a command (hereinafter, referred to as a “bus master DMA transfer command) 11 for execution of DMA along with bus master transfer. The transfer of the address settings 10a to 10c and the bus master DMA transfer command 11 is performed in the single edge synchronization.

When the memory device 103 receives the bus master DMA transfer command 11, the data communication unit 133 controls the memory device 103 to operate as a bus master, and also performs data transfer in double edge synchronization.

More specifically, the memory device 103 issues a read command for reading the SG table 13, reads the SG table 13 from the host PC 101, and stores information included in the SG table 13 in a transfer-destination address register and a transferred-word register provided in the memory device 103. The memory device 103 issues a write command and starts transfer of main data 15 based on the information stored in the registers. Upon completion of the data transfer, the memory device 103 reads the next SG table from the host PC 101 and performs data transfer in the same way. In the SG table, information indicative of whether the data ends or continues is described, and reading of the SG table and data transfer are successively repeated until the end of data is detected from the SG tables. After the completion of the transfer of all the data, a notification 17 of the completion of transfer is issued.

As described above, until the bus master DMA command is issued, the access is made at the timing synchronized with either one of the rising edge or falling edge of the clock (namely, in the single edge synchronization). During a period for which DMA transfer is performed with the memory device 103 serving as a bus master, data transfer is performed in synchronization with both the rising edge and falling edge of the clock (namely, in the double edge synchronization). Thus, in the present embodiment, data transfer performed in the double edge synchronization allows the transfer speed to increase. In this case, regarding accesses to the registers, the host PC 101 accesses the memory device 103 in the single edge synchronization, similarly to conventional interfaces, and therefore the compatibility with existing interfaces can be maintained. This enables the memory device 103 to be connected with a conventional adaptor which does not support the extended function.

Further, in the aforementioned description, when the memory device 103 receives a bus master DMA transfer command after enabling the extended function of the memory device 103 in advance, data is transferred in the double edge synchronization. Instead, a new transfer command (hereinafter, referred to as a “double-edge synchronization bus master DMA transfer command”) may be defined, which is for instructing that data is transferred in the double edge synchronization and by the memory device serving as a bus master. Further, instead of enabling the extended function, the double-edge synchronization bus master DMA transfer command may be issued to the memory device 103, to perform data transfer in the double edge synchronization. In this case, when receiving a double-edge synchronization bus master DMA transfer command from the adaptor 102 which supports the extended function, the memory device 103 operates as a master to transfer data in the double edge synchronization. On the other hand, when the memory device 103 is connected to the host PC 101 or a conventional adaptor, the memory device 103 operates to transfer data in the single edge synchronization in response to a conventional bus master DMA transfer command. Thus, the memory device 103 is capable of realizing high-speed data transfer in cases where it is connected to an apparatus supporting the extended function, while maintaining the interface compatibility with conventional apparatuses.

Further, the adaptor 102 may acquire, as device information about the memory device 103, the writing and reading speed performance of the memory device, current consumptions for writing and reading operations in the double edge synchronization mode, and current consumptions for writing and reading operation in the single edge synchronization mode. Based on the acquired information, the adaptor 102 may switch between a request for DMA transfer in the double edge synchronization and a request for DMA transfer in the single edge synchronization. This can reduce the power consumption without increasing the interface transfer speed more than required.

3. Conclusion

As described above, in the present embodiment, when the memory device 103 supports the extended function, the extended function of the memory device 103 is enabled by the adaptor 102, resulting in data transfer in the double edge synchronization. This enables data transfer at a higher speed than that inherent to the bus interface in the memory device 103.

Further, in the present embodiment, the memory device 103 operates to serve as a bus master during the data transfer operation. Since the memory device 103 operates as a bus master, the data transfer can be controlled on the memory device 103 side. This enables the memory device 103 to determine the state of itself and to set the access speed according to the state. For example, the memory device 103 may acquire information about temperature of the memory device 103 from a temperature sensor mounted in the memory device 103 or information about ambient temperature from the outside. In this case, the memory device 103 can set the access speed low (transfer in the single edge synchronization) to suppress amount of heat generation, if the temperature reaches a high temperature. Further, the memory device 103 can confirm state of stored data in the buffer memory 134 incorporated in the memory device 103 and can switch the access speed (between the single edge synchronization mode and the double edge synchronization mode). This operation is detailed in a third embodiment.

Further, while, in the aforementioned example, the bus master DMA transfer command is issued by the adaptor 102, it can be issued by the host PC 101 and can be transmitted to the memory device 103 through the adaptor 102.

### Second Embodiment

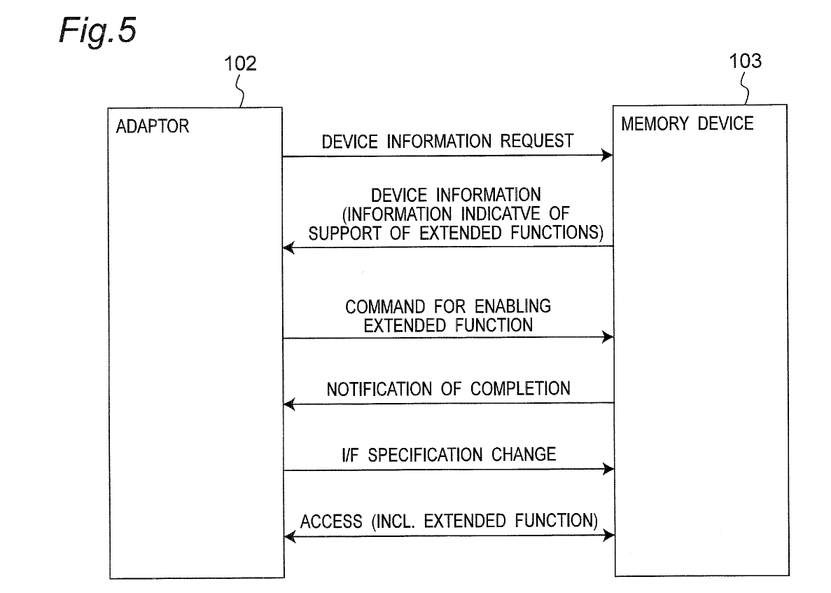

With reference to FIGS. 5 to 7, operations of a memory device 103 and an adaptor (a memory device controller) 102 according to the second embodiment is described below. The memory device 103 and the adaptor (the memory device controller) 102 according to the present embodiment basically have the same structure and perform the same operations as those of the first embodiment, and the same functions and structure are not described hereinafter. In the present embodiment, in order to enable high-speed data transfer as an extended function, the interface specification is changed.

FIG. 5 is a view illustrating the transmission and reception of commands and data between the adaptor 102 and the memory device 103 according to the present embodiment.

When the memory device 103 is mounted to the adaptor 102, the adaptor 102 requests the device information from the memory device 103. In response to the request for the device information, the memory device 103 transmits the device information to the adaptor 102. In the present embodiment, the device information can include, for example, information about an I/O voltage, a type of clock signal, a maximum operation frequency, a data-I/O method, and the like.

The adaptor 102 determines whether or not the memory device 103 supports the extended function based on the device information. If the adaptor 102 determines that the memory device 103 supports it, the adaptor 102 outputs, to the memory device 103, a command for enabling the extended function. The memory device 103 enables the extended function according to the command for enabling the extended function from the adaptor 103.

After completing the processing for enabling the extended function, the memory device 103 transmits a notification of the completion to the adaptor 102. On receiving the notification of the completion of enabling the extended function from the memory device 103, the adaptor 102 changes the interface specification to support the extended function and starts access to the memory device 103.

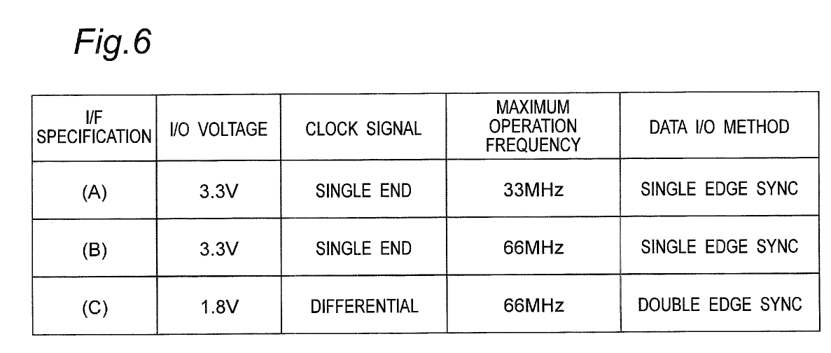

Operation for changing the specification of the interface between the adaptor 102 and the memory device 103 is detailed below. FIG. 6 is a view illustrating information about the extended function relating to interface specification to be set to the memory device. This information is required to be stored at least in the adaptor 102, but the same information may be stored in the memory device 103.

In FIG. 6, a specification (A) indicates a CardBus standard (a PCMCIA standard), and specifications (B) and (C) indicate extended specifications. More specifically, the specification (B) indicates a specification having an I/O voltage of 3.3 V, a single-end clock signal, a maximum operation frequency of 66 MHz, and single edge synchronization. The specification (C) indicates a specification having an I/O voltage of 1.8 V, a differential signal as a clock signal, a maximum operation frequency of 66 MHz, and double edge synchronization.

Immediately after the power-on of the host PC 101 or immediately after the connection of the memory device 103 to the adaptor 102, the adaptor 102 and the memory device 103 are connected through an interface which conforms to the CardBus standard. At this time, if the extended function enabling unit 121 in the adaptor 102 determines that the memory device 103 has extended function(s) based on the device information received from the memory device 103, the extended function enabling unit 121 selects an extended function which is supported by the memory device 103 and switches the interface specification. For example, the extended function enabling unit 121 selects a specification which is supported by the memory device 103 and realizes a higher speed from the I/F specifications indicated by the specifications (B) and (C) in FIG. 6 based on the device information (the I/O voltage, the maximum operation frequency, and the like) of the memory device 103, and then sets I/F specification to the selected I/F specification.

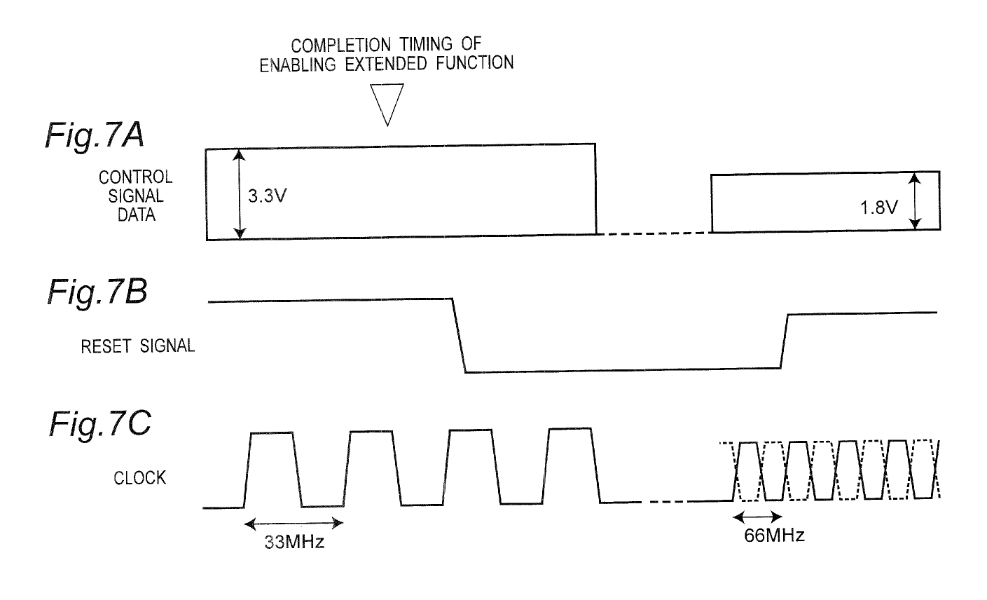

FIGS. 7A to 7C are views illustrating a timing of switch of the interface specification. FIGS. 7A to 7C illustrates switch from the specification (A) to the specification (C).

As illustrated in FIGS. 7A to 7C, after receiving a notification of completion of enabling the extended function from the memory device 103 (see FIG. 7A), the adaptor 102 switches the I/O voltage for signals other than the clock signal, such as control signals and data, from 3.3 V to 1.8 V and asserts a reset signal (see FIG. 7B). After asserting the reset signal, the adaptor 102 switches the output of the clock signal from a single end signal of 3.3 V and 33 MHz (the specification (A)) to a differential signal of 1.8 V and 66 MHz (the specification (C)), and then deasserts the reset signal (see FIGS. 7A to B). After notifying the adaptor 102 of the completion of the enabling the extended function, the memory device 103 changes the I/O voltage to 1.8 V and switches the clock signal from the single end signal to the differential signal by the reset signal. After the resetting, the interface between the adaptor 102 and the memory device 103 operates in the double edge synchronization with the 66 MHz clock, which enables transfer at a speed which is four times that of a conventional CardBus standard.

As described above, in the present embodiment, by switching of the I/F specification of the memory device 103 a, a higher speed is achieved. Further, also in the present embodiment, the memory device 103 operates as a master to transfer data in the double edge synchronization, after the change of the I/F specification.

### Third Embodiment

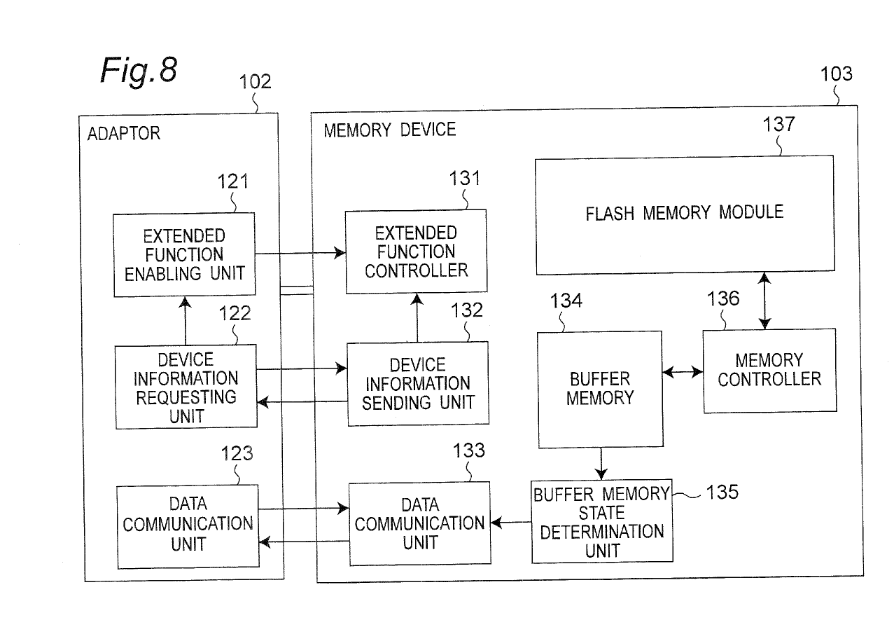

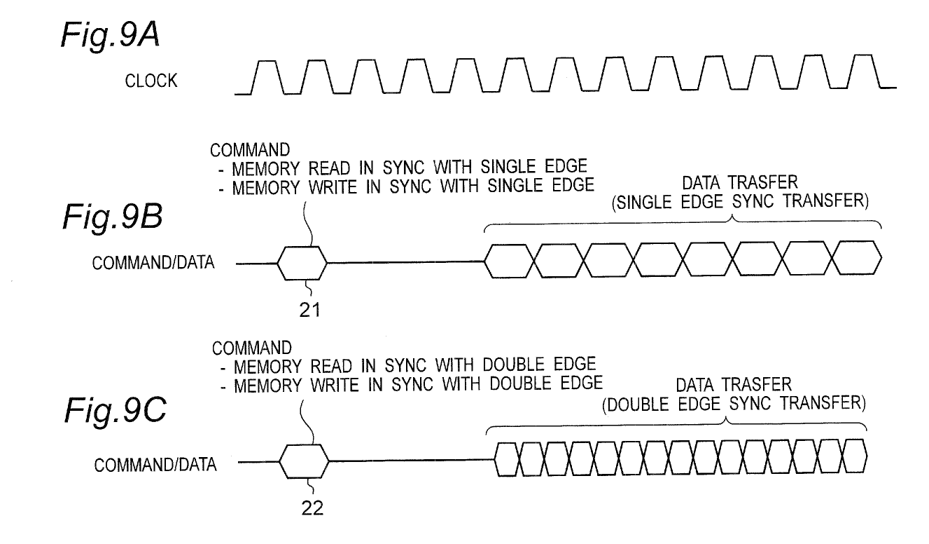

FIG. 8 is a view illustrating a structure of a memory device and an adapter (a memory device controller) according to the third embodiment. FIGS. 9A to 9C are views for describing, in detail, operations of the memory device and the adapter (the memory device controller) according to the third embodiment. The same components as those illustrated in FIG. 1 are designated by the same reference characters and are not described in detail.

As illustrated in FIG. 8, the memory device 103 according to the present embodiment includes a buffer memory state determination unit 135 in addition to the components of the memory device illustrated in FIG. 1. The data communication unit 133 switches the data transfer speed according to the result of determination by the buffer memory state determination unit 135.

Upon receiving a bus master DMA transfer command after enabling the extended function, the memory device 103 issues, to the adaptor 102, a single-edge synchronization memory-access command or a double-edge synchronization memory-access command, and transfers data.

Operations of the memory device 103 in response to a bus master DMA transfer command after the enabling of the extended function.

### <Writing of Data in the Memory Device>

First, a case where data is written in the memory device 103 is described. The adaptor 102 issues a bus master DMA write command to the memory device 103. On receiving the bus master DMA write command, the memory device 103 operates as a master and performs an operation for reading data from the adaptor 102 (the host PC 101) in order to write data in the memory device 103.

In order to acquire an SG table indicating a transfer destination address and a size, the memory device 103 issues a double-edge synchronization memory read command 22 to the adaptor 102 (the host PC 101) and reads data in the SG table in the double edge synchronization using the double edges of the clock signal. Further, the memory device 103 transfers (reads) data from the adaptor 102 based on the information in the SG table. The data transferred from the adaptor 102 is temporarily stored in the buffer memory 134. Thereafter, the data is read from the buffer memory 134 and is written into the flash memory module 137.

At this time, the buffer memory state determination unit 135 compares the free space in the buffer memory 134 and two thresholds “a” and “b” (0<a<b <the capacity of the buffer memory 134) to determine the state of the free area in the buffer memory 134. The data communication unit 133 switches between memory read commands 21 and 22 to be issued to the adaptor 102 according to the free space in the buffer memory 134.

More specifically, when the free space is larger than “b”, the data communication unit 133 performs control to perform reading of memory in the double-edge synchronization. In this case, since the buffer memory 134 has a large free space, writing is performed at a higher speed. When the free space is larger than “a” but is smaller than “b”, the data communication unit 133 performs control to perform reading of memory in the single edge synchronization. In this case, since the free space is insufficient, even if data is transferred in the double edge synchronization, sufficient effect of high-speed transfer may not be achieved even though electric power is consumed. Accordingly, the data communication unit 133 gives a higher priority to reduction of power consumption than that given to the transfer speed, so that the interface transfer speed is prevent from increasing more than necessity and the power consumption is reduced. When the free space is smaller than “a”, the data communication unit 133 does not perform reading of memory because it is considered that a sufficient free space to write data is not secured.

As described above, when the buffer memory 134 has a sufficient free space in writing data to the memory device 103, data transfer in the double edge synchronization with the clock allows the transfer speed to increase. On the other hand, when the buffer memory 134 has a small free space, data transfer in the single edge synchronization can reduce the power consumption without increasing the interface transfer speed more than necessity.

Further, as illustrated in FIGS. 9B and C, the synchronization memory read command 21 or 22 is always transferred in the single edge synchronization, and thereafter data transfer is performed in the double edge synchronization or single edge synchronization according to the type of the memory read command 21 or 22.

<Reading of Data from Memory Device>

Next, a case where data is read from the memory device 103 is described below. The adaptor 102 issues a bus master DMA read command to the memory device 103. On receiving the bus master DMA read command, the memory device 103 operates as a master and performs operation for writing data in the adaptor 102 (the host PC 101) in order to read data from the memory device 103.

In order to acquire an SG table indicating a transfer destination address and a size, the memory device 103 issues a double-edge synchronization memory read command to the adaptor 102 (the host PC 101) and reads data of the SG table in the double edge synchronization with the clock signal. Further, the memory device 103 transfers (writes) data to the adaptor 102 based on the information of the SG table. The data read from the flash memory module 137 is temporarily stored in the buffer memory 134. Thereafter, the data is read from the buffer memory 134 and is transferred to the adaptor 102.

At this time, the buffer memory state determination unit 135 compares amount of data stored in the buffer memory 134 with two threshold values “a” and “b” (0<a<b<the capacity of the buffer memory 134). The data communication unit 133 switches the memory write command to be issued to the adaptor 102 according to the amount of data stored in the buffer memory 134.

More specifically, when the amount of stored data is larger than “b”, the data communication unit 133 performs control such that writing of memory is performed in the double-edge synchronization, since it is determined that amount of data to be transferred is sufficiently large. When the amount of stored data is larger than “a” but is smaller than “b”, the data communication unit 133 performs control such that writing of memory is performed in the single edge synchronization. In this case, since the amount of stored data is smaller, even if data is transferred in the double edge synchronization, sufficient effect of high-speed transfer may not be achieved even though electric power is consumed. Accordingly, the data communication unit 133 gives a higher priority to reduction of the power consumption than that given to the transfer speed, so that the interface transfer speed is prevent from increasing more than necessity and the power consumption is reduced. When the amount of stored data is smaller than “a”, the data communication unit 133 does not perform writing of memory.

Further, as illustrated in FIGS. 9B and C, the synchronization memory write command 21 or 22 is always transferred in the single edge synchronization, and thereafter data transfer is performed in the double edge synchronization or single edge synchronization according to the type of the memory write command 21 or 22.

In this way, when the buffer memory 134 has a sufficient amount of stored data in reading data from the memory device 103, data transfer in the double edge synchronization with the clock allows the transfer speed to increase. On the other hand, when the buffer memory 134 has a small amount of stored data, data transfer in the single edge synchronization can reduce the power consumption without increasing the interface transfer speed more than necessity.

As described above, in the present embodiment, the memory device 103 operates as a bus master, and therefore, state of stored data in the buffer memory 134 (or state of the free space thereof) can be recognized and can properly switch the data transfer speed according to the state. This enables data transfer in the double edge synchronization only when high-speed transfer is generally effective, so that the power consumption can be reduced while realizing high-speed transfer.

### INDUSTRIAL APPLICABILITY

According to the present embodiment, when a memory device which is designed to be connected through a conventional standard PC interface is connected to a memory device controller through an interface having a higher speed than that of the standard PC interface, the transfer speed can be increased. Accordingly, the memory device and memory device controller according to the present embodiment is usable for a memory device such as a nonvolatile memory device as a recording medium used for a personal computer (PC) or a digital camera, and a memory device controller thereof.

1. A memory device connectable to a host device via a memory device controller, comprising:
a memory module for storing data; and
a data communication unit configured to communicate data with the memory device controller in synchronization with a predetermined clock signal, in order to write or read data to or from the memory module,
wherein the data communication unit is capable of transferring data in a single edge synchronization mode in which data is transferred in synchronization with either one of a rising edge and a falling edge of the clock signal or in a double edge synchronization mode in which data is transferred in synchronization with both the rising edge and the falling edge,
the memory device can be set to operate as a bus master, and
when the memory device is set to operate as a bus master, the data communication unit transfers data in the double edge synchronization mode.

2. The memory device according to claim 1, further comprising a buffer memory for temporarily storing data to be read from the memory module or data to be written in the memory module,
wherein when data is transferred with the memory device operating as a bus master, the data communication unit switches between the single edge synchronization mode and the double edge synchronization mode, according to state of stored data in the buffer memory.

3. The memory device according to claim 2, further comprising a determination unit configured to determine a free space of the buffer memory,
wherein when data is transferred to the memory device operating as a bus master from the memory device controller, based on the result of determination by the determination unit, the data communication unit transfers data in the double edge synchronization mode when the free space of the buffer memory is equal to or more than a predetermined value, and transfers data in the single edge synchronization mode when the free space of the buffer memory is less than the predetermined value.

4. The memory device according to claim 2, further comprising a determination unit configured to determine amount of data stored in the buffer memory,
wherein when data is transferred from the memory device operating as a bus master to the memory device controller, based on the result of determination by the determination unit, the data communication unit transfers data in the double edge synchronization mode when the amount of data stored in the buffer memory is equal to or more than a predetermined value, and transfers data in the single edge synchronization mode when the amount of data stored in the buffer memory is less than the predetermined value.

5. A memory device controller interposed between a memory device and a host device and connectable to the memory device through a predetermined interface, the memory device controller comprising a data communication unit configured to transfer data to and from the memory device in synchronization with a clock signal,
wherein the data communication unit supports a single edge synchronization mode in which data is transferred in synchronization with either one of a rising edge and a falling edge of the clock signal, and a double edge synchronization mode in which data is transferred in synchronization with both the rising edge and the falling edge, and
the data communication unit transfers data in the double edge synchronization mode when data is transferred by the memory device operating as a bus master.

6. The memory device controller according to claim 5, further comprising a device information requesting unit configured to request device information from the memory device when connection of the memory device to the memory device controller is detected,
wherein the data communication unit switches between transfer in the double edge synchronization mode and transfer in the single edge synchronization mode based on the device information acquired from the memory device, to transfer data.

7. The memory device controller according to claim 6, which determines whether or not the memory device supports the double edge synchronization mode based on the device information received from the memory device, and transmits, to the memory device, a command for commanding the memory device to operate as a bus master and transfer data in the double edge synchronization mode, when the memory device supports the double edge synchronization mode.

8. The memory device controller according to claim 6, which determines an interface specification which is supported by the memory device based on the device information received from the memory device, and changes an interface specification of the memory device to the interface specification determined to be supported by the memory device.

9. The memory device controller according to claim 6, wherein the device information includes information about speed of at least one of writing and reading data to and from the memory device.

10. The memory device controller according to claim 6, wherein the device information includes information about current consumptions for writing and reading data in the double edge synchronization mode and information about current consumptions for writing and reading data in the single edge synchronization mode.
